(19) United States
(12) Patent Application Publication
(10) Pub. No.: US 2025/0130466 A1
(43) Pub. Date: Apr. 24, 2025

(54) DISPLAY PANEL

(71) Applicant: HannStar Display Corporation, Taipei City (TW)

(72) Inventors: Qi-En Luo, Chiayi County (TW); Cheng-Yen Yeh, Taichung City (TW); Yen-Chung Chen, Taichung City (TW); Mu-Kai Kang, Tainan City (TW); Jing-Xuan Chen, Tainan City (TW); Shao-Chien Chang, Taoyuan City (TW)

(73) Assignee: HannStar Display Corporation, Taipei City (TW)

(21) Appl. No.: 18/629,953

(22) Filed: Apr. 9, 2024

(30) Foreign Application Priority Data
Oct. 18, 2023 (CN) 202311348855.9

(51) Int. Cl. G02F 1/1362; G02F 1/1335; G02F 1/1343; G02F 1/1345; G02F 1/1368

(52) U.S. Cl. CPC G02F 1/136209; G02F 1/133553; G02F 1/134363; G02F 1/134372; G02F 1/13454; G02F 1/136286; G02F 1/1368

(57) ABSTRACT

A display panel including a substrate, scan lines, data lines, pixel structures, and a light shielding pattern layer is provided. The substrate is provided with a display area. The scan lines and the data lines are disposed on the substrate, and intersect with each other. The pixel structures are disposed in the display area, and each includes a display transistor and a pixel electrode. The display transistor includes a first semiconductor pattern, a first gate electrode, a first source electrode, and a first drain electrode. The first gate electrode is disposed between the substrate and the first semiconductor pattern, and is electrically connected to one of the scan lines. The first source electrode is electrically connected to one of the data lines. The pixel electrode is electrically connected to the first drain electrode of the display transistor. The light shielding pattern layer is disposed between the first gate electrode and the substrate, and has a first opening overlapping the first gate electrode.

### CROSS-REFERENCE TO RELATED APPLICATION

This application claims the priority benefit of China application serial no. 202311348855.9, filed on Oct. 18, 2023. The entirety of the above-mentioned patent application is hereby incorporated by reference herein and made a part of this specification.

### BACKGROUND

### Technical Field

The disclosure relates to a display technology, and particularly relates to a display panel.

### Description of Related Art

Most of the current mainstream display panels use thin film transistors to implement active control of display pixels. However, thin film transistors are often prone to leakage due to illumination of light sources (regardless of whether backlight or ambient light), resulting in poor electrical properties of pixel structures and affecting display quality.

### SUMMARY

The disclosure is directed to a display panel with better operating electrical properties.

The disclosure provides a display panel including a substrate, multiple scan lines, multiple data lines, multiple pixel structures, and a light shielding pattern layer. The substrate is provided with a display area. The scan lines and the data lines are disposed on the substrate, and intersect with each other. The pixel structures are disposed in the display area, and respectively include a display transistor and a pixel electrode. The display transistor includes a first semiconductor pattern, a first gate electrode, a first source electrode, and a first drain electrode. The first gate electrode is disposed between the substrate and the first semiconductor pattern, and is electrically connected to one of the scan lines. The first source electrode is electrically connected to one of the data lines. The pixel electrode is electrically connected to the first drain electrode of the display transistor. The light shielding pattern layer is disposed between the first gate electrode and the substrate, and has a first opening overlapping the first gate electrode.

In an embodiment of the disclosure, an orthogonal projection of the first opening of the light shielding pattern layer of the display panel on the substrate is located within an orthogonal projection of the first gate electrode on the substrate.

In an embodiment of the disclosure, an orthogonal projection of the light shielding pattern layer of the display panel on the substrate surrounds an orthogonal projection of the first gate electrode on the substrate.

In an embodiment of the disclosure, each of the pixel structures of the display panel further includes a common electrode, which is disposed between the pixel electrode and the substrate and overlaps the pixel electrode. Orthogonal projections of the common electrode and the first gate electrode on the substrate have a first gap, and the first gap is located within an orthogonal projection of the light shielding pattern layer on the substrate.

In an embodiment of the disclosure, orthogonal projections of the common electrode of the display panel and an adjacent one of the data lines on the substrate have a second gap, and the second gap is located within the orthogonal projection of the light shielding pattern layer on the substrate.

In an embodiment of the disclosure, orthogonal projections of the common electrode of the display panel and an adjacent one of the scan lines on the substrate have a third gap, and the third gap is located within the orthogonal projection of the light shielding pattern layer on the substrate.

In an embodiment of the disclosure, each of the pixel structures of the display panel further includes a reflective layer and a capacitive electrode. The reflective layer covers the pixel electrode and is electrically connected to the pixel electrode. The reflective layer defines a reflective area of the pixel structure, and a portion of the pixel electrode that is not covered by the reflective layer defines a transmissive area of the pixel structure. The capacitive electrode is disposed in the reflective area and overlaps the common electrode. The pixel electrode is electrically connected to the first drain electrode of the display transistor through the capacitive electrode.

In an embodiment of the disclosure, the orthogonal projection of the light shielding pattern layer of the display panel on the substrate surrounds an orthogonal projection of the common electrode on the substrate.

In an embodiment of the disclosure, the light shielding pattern layer of the display panel has a floating potential.

In an embodiment of the disclosure, the display panel further includes a gate driving circuit, which is disposed in a peripheral area outside the display area and includes multiple shift register circuits. The shift register circuits are electrically connected to the scan lines respectively, and each of the shift register circuits includes multiple transistors. Each of the transistors includes a second semiconductor pattern, a second gate electrode, a second source electrode, and a second drain electrode. The second gate electrode is disposed between the substrate and the second semiconductor pattern. The second source electrode and the second drain electrode respectively contact two different areas of the second semiconductor pattern. The light shielding pattern layer further has a second opening overlapping the second gate electrode.

In an embodiment of the disclosure, an orthogonal projection of the second opening of the light shielding pattern layer of the display panel on the substrate is located within an orthogonal projection of the second gate electrode on the substrate.

In an embodiment of the disclosure, an orthogonal projection of the light shielding pattern layer of the display panel on the substrate surrounds an orthogonal projection of the second gate electrode on the substrate.

In an embodiment of the disclosure, the display panel further includes a glue pattern and multiple signal lines. The glue pattern is disposed in the peripheral area. The signal lines are disposed in the peripheral area and are electrically connected to the shift register circuits. A light transmittance of portions of the signal lines, the shift register circuits, and the light shielding pattern layer covered by the glue pattern is greater than 38%.

In an embodiment of the disclosure, the glue pattern of the display panel has an outer edge away from the display area, and a distance between one of the signal lines closest to the outer edge of the glue pattern and the outer edge is within a range of 200 μm to 250 μm.

In an embodiment of the disclosure, each of the shift register circuits of the display panel includes an output stage circuit. The output stage circuit is configured with an output transistor of the transistors. The second gate electrode of the output transistor is electrically connected to a pull-down circuit and a pull-up circuit. The second drain electrode of the output transistor is electrically connected to one of the scan lines. The second source electrode of the output transistor is electrically connected to a clock signal line. The pull-down circuit and the pull-up circuit are respectively configured with a part of the transistors.

In an embodiment of the disclosure, the light shielding pattern layer of the display panel includes multiple light shielding patterns separated from each other. The light shielding patterns respectively have the first openings overlapping the first gate electrodes of the display transistors.

In an embodiment of the disclosure, the pixel structures of the display panel respectively include a common electrode, which is disposed on the substrate and overlaps the pixel electrode. The common electrode has an opening overlapping the first semiconductor pattern.

In an embodiment of the disclosure, the pixel electrode of the display panel is located between the common electrode and the substrate. The common electrode is configured with multiple micro-slits, and the micro-slits overlap the pixel electrode.

In an embodiment of the disclosure, the common electrode of the display panel further overlaps one of the data lines and one of the scan lines.

In an embodiment of the disclosure, the light shielding pattern layer of the display panel is a metal layer or a black resin material layer.

Based on the above description, in the display panel according to an embodiment of the disclosure, since the light shielding pattern layer is provided between the first gate electrode of the display transistor of the pixel structure and the substrate, a leakage problem of the display transistor caused by the light being incident around the first gate or being irradiated to the first semiconductor pattern after multiple reflections by the first gate electrode, the first source electrode and the first drain electrode is avoided, so as to ensure operating electrical properties of the display panel under light sources from different directions. In addition, through the openings provided in the light shielding pattern layer at a place overlapping the first gate electrode, flatness of a film layer around the display transistor is further improved, which helps to improve a yield of a subsequent film-forming process.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic front view of a display panel according to a first embodiment of the disclosure.

FIG. 2A is an enlarged front view of a partial area of the display panel of FIG. 1.

FIG. 2B is an enlarged rear view of the partial area of the display panel of FIG. 1.

FIG. 3 is a schematic cross-sectional view of the display panel of FIG. 2A.

FIG. 4 is a schematic front view of a display panel according to a second embodiment of the disclosure.

FIG. 5A is an enlarged front view of a partial area of the display panel of FIG. 4.

FIG. 5B is an enlarged rear view of a partial area of the display panel of FIG. 4.

FIG. 6A to 6C are enlarged front views of a part of film layers of the display panel of FIG. 5A.

FIG. 7 is a schematic cross-sectional view of the display panel of FIG. 5A.

FIG. 8A is a schematic front view of a display panel according to a third embodiment of the disclosure.

FIG. 8B is a schematic rear view of the display panel of FIG. 8A.

FIG. 9 is a schematic cross-sectional view of the display panel of FIG. 8A.

### DESCRIPTION OF The EMBODIMENTS

A term “couple (or connect)” used in the full text of the disclosure (including the claims) refers to any direct and indirect connections. For example, if a first device is described to be coupled (or connected) to a second device, it is interpreted as that the first device is directly coupled to the second device, or the first device is indirectly coupled to the second device through other devices or connection means. Terms such as “first”, “second”, etc., mentioned in the specification and the claims are used to name the elements or to distinguish different embodiments or scopes and should not be regarded as limiting an upper or lower bound of the number of the components/devices, or an order of the components.

Reference will now be made in detail to the exemplary embodiments of the disclosure, examples of which are illustrated in the accompanying drawings. Whenever possible, the same reference numbers are used in the drawings and descriptions to refer to the same or similar parts.

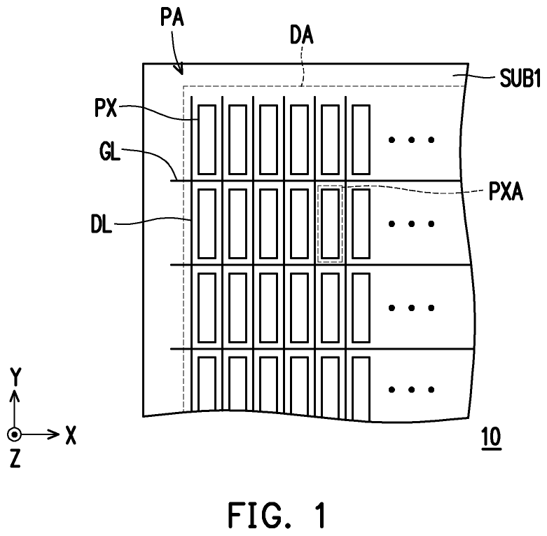

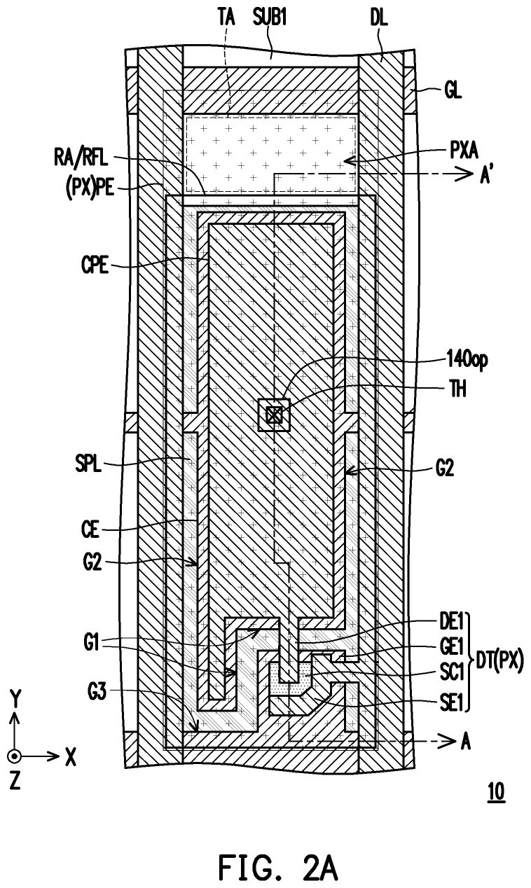

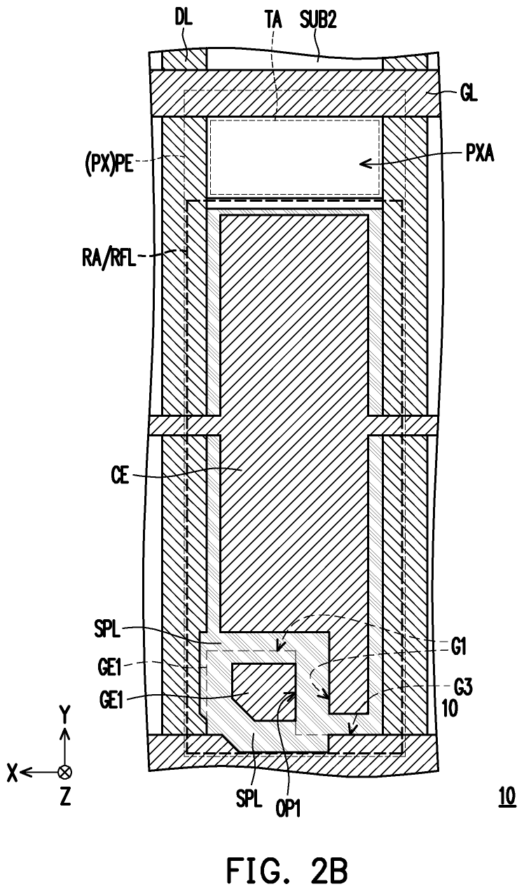

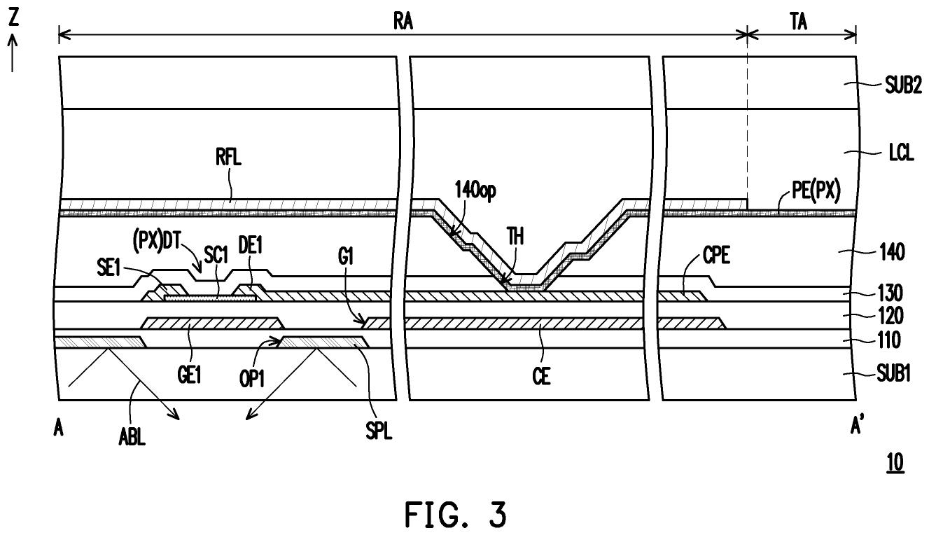

FIG. 1 is a schematic front view of a display panel according to a first embodiment of the disclosure. FIG. 2A is an enlarged front view of a partial area of the display panel of FIG. 1. FIG. 2B is an enlarged rear view of the partial area of the display panel of FIG. 1. FIG. 3 is a schematic cross-sectional view of the display panel of FIG. 2A. FIG. 3 corresponds to a section line A-A′ of FIG. 2A.

Referring to FIG. 1 and FIG. 2A, a display panel 10 includes a substrate SUB1, multiple scan lines GL, multiple data lines DL and multiple pixel structures PX. The substrate SUB1 is provided with a display area DA and a peripheral area PA outside the display area DA. The scan lines GL and the data lines DL are disposed on the substrate SUB1 and intersect with each other to define multiple pixel areas PXA. For example, in the embodiment, the data lines DL may be arranged along a direction X and extend in a direction Y, and the scan lines GL may be arranged along the direction Y and extend in the direction X.

The pixel structures PX are disposed in the display area DA, and are respectively located in the pixel areas PXA. The pixel structures PX respectively include a display transistor DT and a pixel electrode PE that are electrically connected to each other. The display transistor DT includes a first semiconductor pattern SC1, a first gate electrode GE1, a first source electrode SE1 and a first drain electrode DE1. The first gate electrode GE1 is disposed between the substrate SUB1 and the first semiconductor pattern SC1 and is electrically connected to one of the scan lines GL. The first source electrode SE1 is electrically connected to one of the data lines DL. The first drain electrode DE1 is electrically connected to the pixel electrode PE.

Referring to FIG. 2A and FIG. 3, a step of forming the display transistor DT include, for example: sequentially forming the first gate electrode GE1, the gate insulating layer 120, the first semiconductor pattern SC1, the first source electrode SE1 and the first drain electrode DE1 on the substrate SUB1. The first semiconductor pattern SC1 overlaps the first gate electrode GE1 along a direction Z. The first source electrode SE1 and the first drain electrode DE1 are electrically connected to two different areas (for example, a source area and a drain area) of the first semiconductor pattern SC1 respectively. In the embodiment, the first gate electrode GE1 of the display transistor DT may be a part extending from the scan line GL, and the first source electrode SE1 may be a part extending from the data line DL, but the disclosure is not limited thereto. It should be noted first that unless otherwise mentioned below, one component overlapping another component refers to an overlapping relationship between the two components along the direction Z, which will not be repeated.

In some embodiments, there is an ohmic contact layer (not shown) between the first source electrode SE1 and the first semiconductor pattern SC1 and between the first drain electrode DE1 and the first semiconductor pattern SC1, and a material of the ohmic contact layer may be, for example, a doped amorphous silicon layer, but the disclosure is not limited thereto. In the embodiment, the first gate electrode GE1 may be selectively disposed below the first semiconductor pattern SC1 to form a bottom-gate type display transistor DT. A material of the gate insulating layer 120 sandwiched between the first gate electrode GEL and the first semiconductor pattern SC1 may include silicon oxide, silicon nitride or other suitable dielectric materials. However, the disclosure is not limited thereto. In other embodiments, the first gate electrode GE1 may also be disposed above the first semiconductor pattern SC1 to form a top-gate type display transistor.

In the embodiment, the display transistor DT is, for example, an amorphous silicon thin film transistor (a-Si TFT), but the disclosure is not limited thereto. In other embodiments, the display transistor DT may also be a polycrystalline silicon TFT (poly-Si TFT) or a metal oxide semiconductor TFT.

In the embodiment, the pixel structure PX may also include a common electrode CE and a capacitive electrode CPE. The common electrode CE is disposed between the capacitive electrode CPE and the substrate SUB1, and overlaps the pixel electrode PE. The capacitive electrode CPE is disposed between the pixel electrode PE and the common electrode CE, and overlaps the common electrode CE. In the embodiment, the common electrode CE and the first gate electrode GE1 may belong to a same film layer. The capacitive electrode CPE, the first source electrode SE1 and the first drain electrode DE1 may belong to a same film layer. Namely, the common electrode CE and the capacitive electrode CPE are configured with the gate insulating layer 120 there between to electrically insulate each other. From another point of view, the overlapped common electrode CE and capacitive electrode CPE may constitute a storage capacitor of the pixel structure PX.

On the other hand, the display transistor DT may also be sequentially covered with an insulating layer 130 and a coating layer 140. The pixel electrode PE is disposed on the coating layer 140 and is electrically connected to the capacitive electrode CPE through an opening 140op of the coating layer 140 and a contact hole TH of the insulating layer 130. In the embodiment, the capacitive electrode CPE may extend from the first drain electrode DE1 of the display transistor DT. Namely, the pixel electrode PE may be electrically connected to the first drain electrode DE1 of the display transistor DT through the capacitive electrode CPE.

The insulating layer 130 is, for example, a passivation layer, and a material thereof includes, for example, silicon nitride, silicon oxide, silicon carbide or aluminum oxide, but the disclosure is not limited thereto. A material of the coating layer 140 may include an inorganic material (such as silicon oxide, silicon nitride, silicon oxynitride, other suitable materials, or a stacked layer of at least two of the above materials), an organic material (such as polyester, polyolefin, polypropylene, polycarbonate, polyalkylene oxide, polystyrene, polyether, polyketone, polyol, polyaldehyde, or other suitable materials, or a combination of the above materials), or other suitable materials, or a combination of the above materials.

Furthermore, in the embodiment, the display panel 10 further includes a light shielding pattern layer SPL, which is disposed between the first gate electrode GE1 and the substrate SUB1 and has a first opening OP1 overlapping the first gate electrode GE1. The light shielding pattern layer SPL and the first gate electrode GE1 are electrically insulated from each other due to an insulating layer 110 provided there between. The insulating layer 110 is, for example, a passivation layer, and a material thereof includes, for example, silicon nitride, silicon oxide, silicon carbide or aluminum oxide, but the disclosure is not limited thereto.

Particularly, orthogonal projections of the common electrode CE and the first gate electrode GE1 on the substrate SUB1 have a first gap G1, and the first gap G1 is located within an orthogonal projection of the light shielding pattern layer SPL on the substrate SUB1. Namely, the light shielding pattern layer SPL may completely shield the first gap G1 between the common electrode CE and the first gate electrode GE1. In the embodiment, an orthogonal projection of the first opening OP1 of the light shielding pattern layer SPL on the substrate SUB1 is located within the orthogonal projection of the first gate electrode GE on the substrate SUB1.

For example, the light shielding pattern layer SPL may further overlap a part of the first gate electrode GE1 and a part of the common electrode CE. Namely, in the embodiment, an area of the orthogonal projection of the first opening OP1 on the substrate SUB1 may be smaller than an area of the orthogonal projection of the first gate electrode GE1 on the substrate SUB1, but the disclosure is not limited thereto. In other embodiments, a profile of the orthogonal projection of the first opening OP1 on the substrate SUB1 may be aligned with a profile of the orthogonal projection of the first gate electrode GE1 on the substrate SUB1.

In the embodiment, the orthogonal projection of the light shielding pattern layer SPL on the substrate SUB1 may surround the orthogonal projection of the first gate electrode GE1 on the substrate SUB2 (as shown in FIG. 2B). Accordingly, it may effectively prevent light (such as ambient light ABL) incident from one side of the substrate SUB1 from irradiating the first semiconductor pattern SC1 through the edge of the first gate electrode GE1, through multiple reflections of the first gate electrode GE1 and the first source electrode SE1, or through multiple reflections of the first gate electrode GE1 and the first drain electrode DE1, so as to ensure that operating electrical properties of the display panel 10 will not be affected by light irradiation.

On the other hand, orthogonal projections of the common electrode CE and the adjacent data line DL on the substrate SUB1 have a second gap G2, and the second gap G2 is located within the orthogonal projection of the light shielding pattern layer SPL on the substrate SUB1. Similarly, orthogonal projections of the common electrode CE and the adjacent scan line GL on the substrate SUB1 have a third gap G3, and the third gap G3 is located within the orthogonal projection of the light shielding pattern layer SPL on the substrate SUB1. Namely, the light shielding pattern layer SPL may completely shield the second gap G2 between the common electrode CE and the adjacent data line DL and the third gap G3 between the common electrode CE and the adjacent scan line GL.

From another perspective, the orthogonal projection of the light shielding pattern layer SPL on the substrate SUB1 may surround the orthogonal projection of the common electrode CE on the substrate SUB1 (as shown in FIG. 2B). Accordingly, a height difference of a metal stack structure in the pixel area PXA may be reduced. In other words, the flatness of the film stack structure in the pixel area PXA may be improved, thereby improving a yield and film quality of a subsequent film-forming process. For example, in the embodiment, the pixel structure PX may further include a reflective layer RFL covering the pixel electrode PE. Through the arrangement of the light shielding pattern layer SPL, the reflective layer RFL formed in the subsequent process may have better surface flatness.

In the embodiment, the reflective layer RFL may be electrically connected to the pixel electrode PE. Namely, the reflective layer RFL of the embodiment may be a reflective electrode. The pixel electrode PE may be a light transmissive electrode. A material of the reflective electrode includes, for example, metals (such as silver, aluminum, platinum), alloys, nitrides of metal materials, oxides of metal materials, oxynitrides of metal materials, or other suitable materials, or a stacked layer of metal materials and other conductive materials. A material of the light transmissive electrode includes, for example, a metal oxide, such as indium tin oxide, indium zinc oxide, aluminum tin oxide, aluminum zinc oxide, or other suitable materials, or a stacked layer of at least two of the above materials.

In the embodiment, the reflective layer RFL may define a reflective area RA of the pixel structure PX, and the part of the pixel electrode PE that is not covered by the reflective layer RFL may define a transmissive area TA of the pixel structure PX. It should be noted that the pixel electrode PE not only overlaps the reflective layer RFL, but also further overlaps the transmissive area TA.

On the other hand, the display panel 10 may further include a liquid crystal layer LCL and another substrate SUB2. The liquid crystal layer LCL is disposed between the substrate SUB1 and the substrate SUB2. More specifically, the display panel 10 of the embodiment may be a micro-transverse liquid crystal display panel.

Furthermore, in the embodiment, the light shielding pattern layer SPL is, for example, a metal layer, and a material thereof includes, for example, molybdenum, aluminum, copper, nickel, chromium, alloys of the above materials, or a stacked structure of the above materials. For example, in the embodiment, the light shielding pattern layer SPL may have a floating potential, but the disclosure is not limited thereto.

Other embodiments will be provided below to describe the disclosure in detail, in which the same components will be indicated by the same symbols, and the description of the same technical content will be omitted. For the omitted parts, please refer to the foregoing embodiments and details thereof are not repeated.

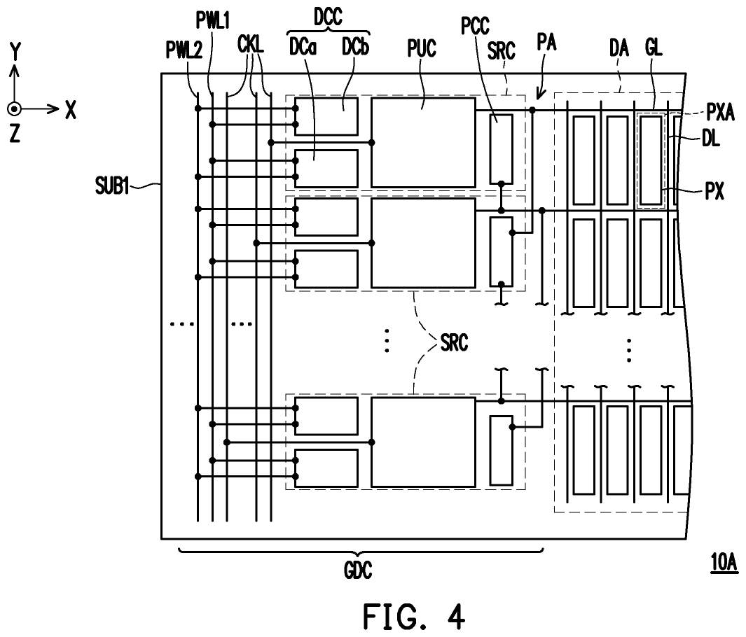

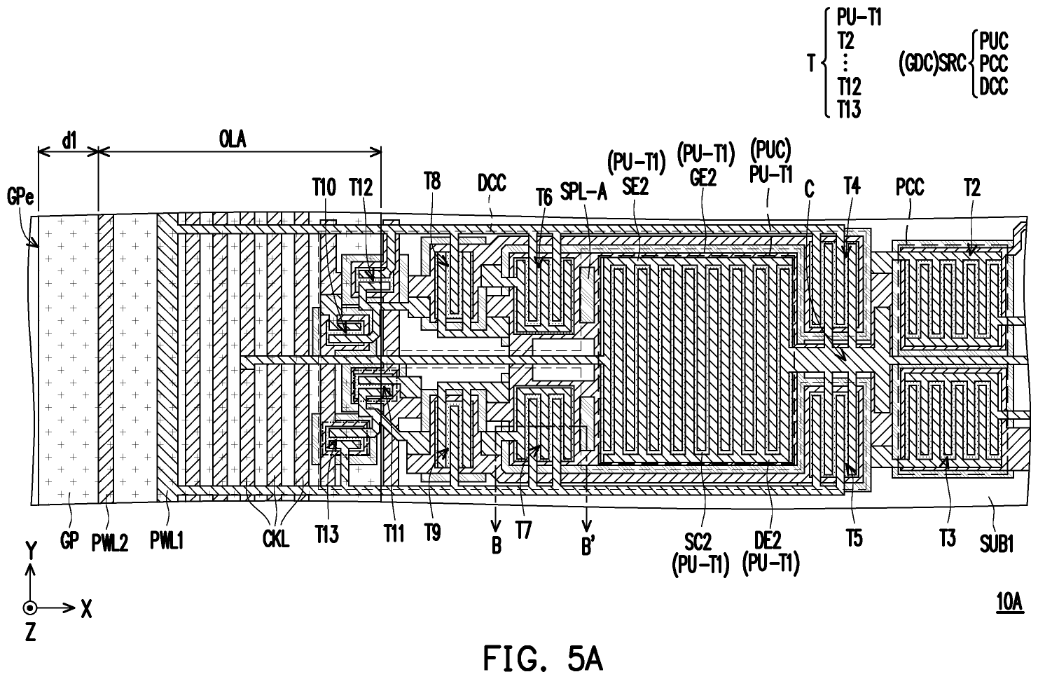

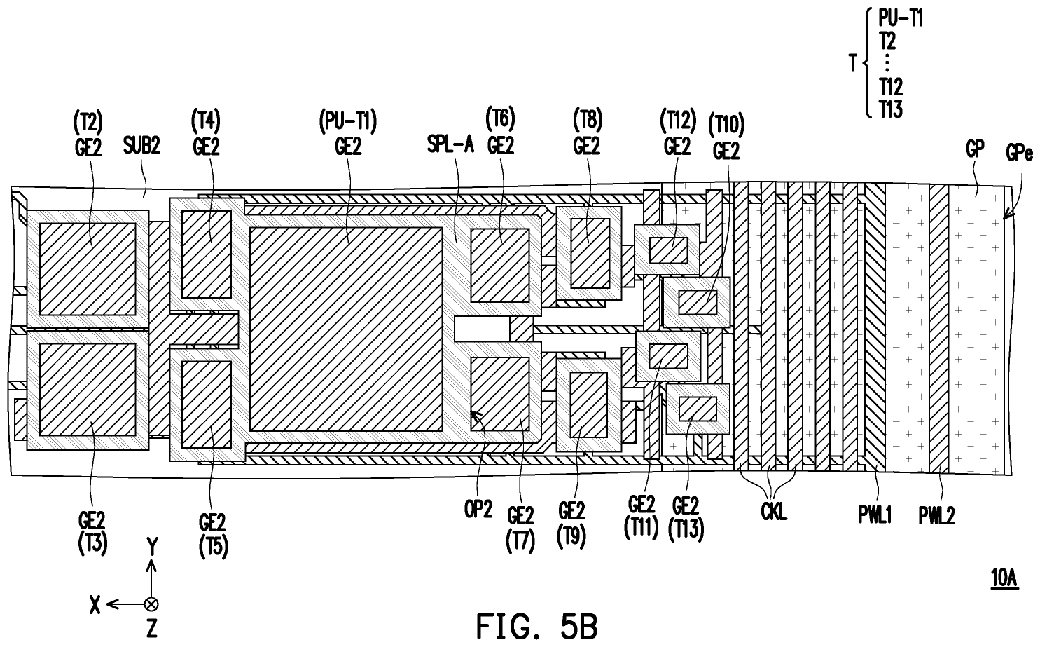

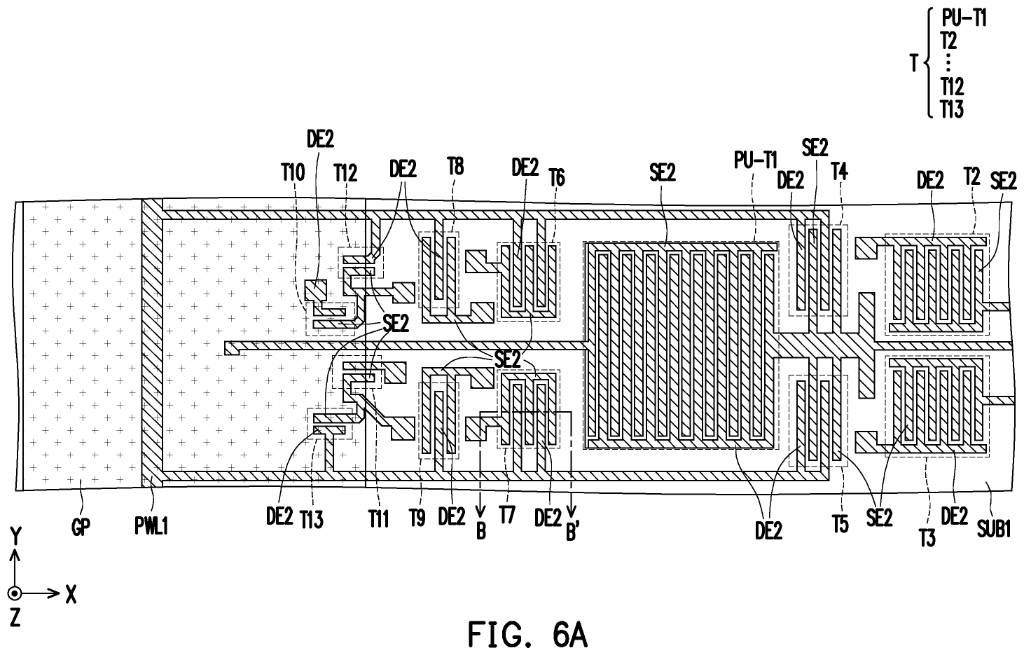

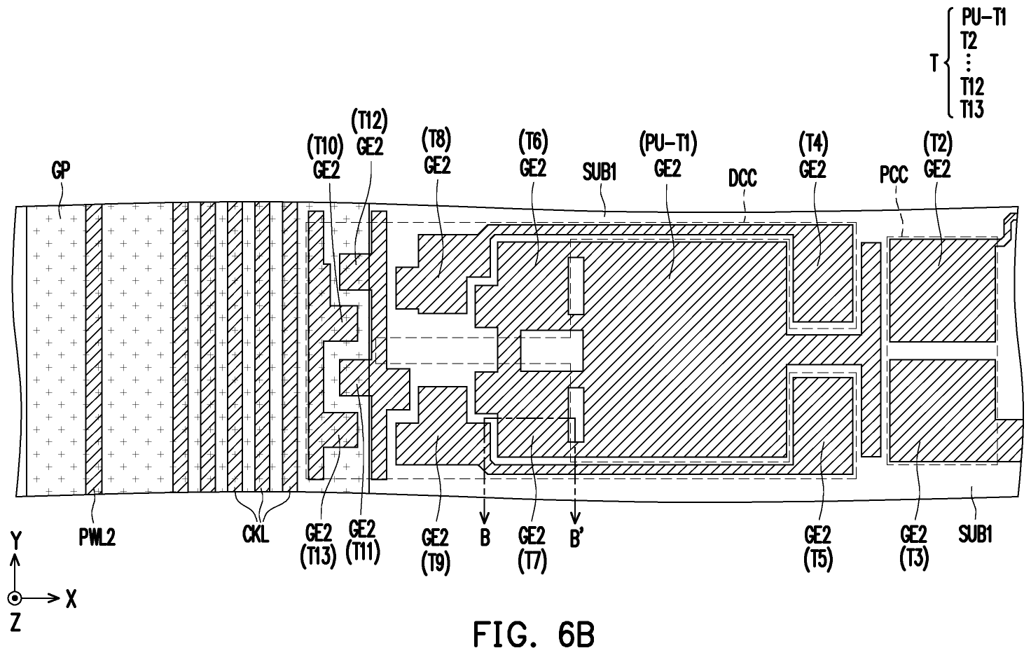

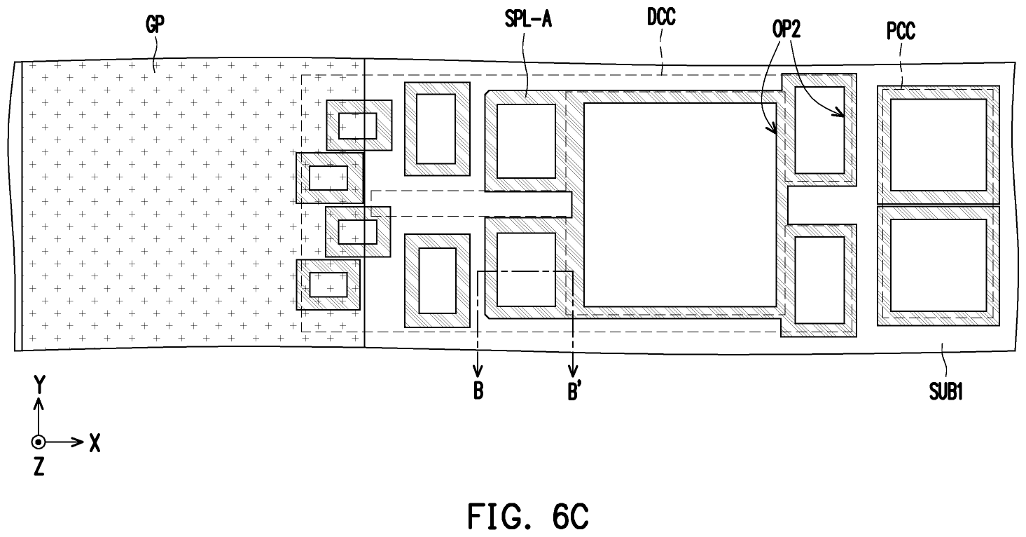

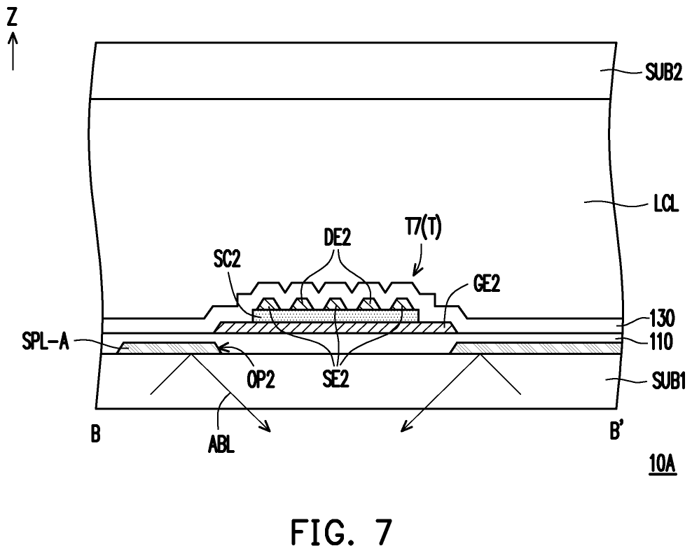

FIG. 4 is a schematic front view of a display panel according to a second embodiment of the disclosure. FIG. 5A is an enlarged front view of a partial area of the display panel of FIG. 4. FIG. 5B is an enlarged rear view of a partial area of the display panel of FIG. 4. FIG. 6A to 6C are enlarged front views of a part of film layers of the display panel of FIG. 5A. FIG. 7 is a schematic cross-sectional view of the display panel of FIG. 5A. FIG. 7 corresponds to a section line B-B′ of FIG. 5A.

Referring to FIG. 4 and FIG. 5A, different from the display panel 10 of FIG. 1 which is only provided with the light shielding pattern layer SPL in the display area DA, a display panel 10A of the embodiment is provided with a light shielding pattern layer SPL-A in both of the display area DA and the peripheral area PA. Since the light shielding pattern layer SPL-A of the display panel 10A of the embodiment is arranged in the display area DA in a manner similar to that of the light shielding pattern layer SPL of the display panel 10 of FIG. 2A, please refer to the relevant paragraphs of the foregoing embodiment for detailed description, and detail thereof is not repeated.

For example, in the embodiment, a gate driving circuit GDC may be provided in the peripheral area PA, and the gate driving circuit GDC may include multiple shift register circuits SRC serially coupled to each other and multiple signal lines. These shift register circuits SRC are electrically connected to multiple scan lines GL respectively, and respectively include multiple transistors T. The signal lines include, for example, multiple clock signal lines CKL and power lines (for example, a power line PWL1 and a power line PWL2), but the disclosure is not limited thereto.

The transistor T includes a second semiconductor pattern SC2, a second gate electrode GE2, a second source electrode SE2, and a second drain electrode DE2. The second gate electrode GE2 is disposed between the substrate SUB1 and the second semiconductor pattern SC2. The second source electrode SE2 and the second drain electrode DE2 respectively contact two different areas (for example, a source area and a drain area) of the second semiconductor pattern SC2.

In the embodiment, the shift register circuit SRC includes an output stage circuit PUC, a pull-up circuit PCC, and a pull-down circuit DCC. The output stage circuit PUC is provided with an output transistor PU-T1 of the aforementioned transistors T and a capacitor C, and the pull-down circuit DCC and the pull-up circuit PCC are respectively provided with a part of the aforementioned transistors T. The output stage circuit PUC is electrically connected to a clock signal line CKL. The pull-down circuit DCC is electrically connected to the power line PWL1 and the power line PWL2.

For example, the pull-up circuit PCC is adapted to pull up a first driving signal according to a scan direction signal (for example, a first scan direction signal or a second scan direction signal). The pull-down circuit DCC is adapted to pull down the first driving signal and output a second driving signal according to a first control signal from the power line PWL1 and a second control signal from the power line PWL2. The output stage circuit PUC is adapted to generate a gate driving signal according to the corresponding clock signal, the first driving signal and the second driving signal.

In the embodiment, a number of the pull-down circuits DCC of the shift register circuit SRC is, for example, two (which are respectively a pull-down circuit DCa and a pull-down circuit DCb), but the disclosure is not limited thereto. In other embodiments, the number of the pull-down circuit of the shift temporary circuit may also be one. On the other hand, the disclosure does not limit the number of the transistors T included in each shift register circuit SRC. The numbers of these components may be adjusted according to an actual circuit design of the product.

Referring to FIG. 5A, FIG. 6A and FIG. 6B, in detail, the pull-up circuit PCC includes a transistor T2 and a transistor T3. The second gate electrode GE2 of the transistor T2 receives a gate driving signal output from a previous stage shift register circuit SRC, the second source electrode SE2 of the transistor T2 receives the first scan direction signal, and the second drain electrode DE2 of the transistor T2 is connected to the second gate electrode GE2 of the output transistor PU-T1, the output stage circuit PUC and the pull-down circuit DCC. The second gate electrode GE2 of the transistor T3 receives the gate driving signal output from a subsequent stage shift register circuit SRC, and the second source electrode SE2 of the transistor T3 receives the second scan direction signal. In the embodiment, the first scan direction signal is configured to indicate a scan direction of the gate driving circuit GDC to be a first direction (for example, scanning from top to bottom in FIG. 4), and the second scan direction signal is configured to indicate the scan direction of the gate driving circuit GDC to be a second direction (for example, scanning from bottom to top in FIG. 4).

The output stage circuit PUC includes an output transistor PU-T1 and a capacitor C. The second gate electrode GE2 and the second drain electrode DE2 of the output transistor PU-T1 are electrically connected to a first terminal and a second terminal of the capacitor C respectively. The second source electrode SE2 of the output transistor PU-T1 receives a clock signal from the clock signal line CKL, the second drain electrode DE2 of the output transistor PU-T1 is connected to the second terminal of the capacitor, and outputs the gate driving signal.

Referring to FIG. 4, FIG. 5A, FIG. 6A and FIG. 6B, the pull-down circuit DCa includes a transistor T4, a transistor T6, a transistor T8, a transistor T10 and a transistor T12. The second source electrode SE2 of the transistor T4 is electrically connected to the second drain electrode DE2 of the output transistor PU-T1. The second gate electrode GE2 of the transistor T6 and the second source electrode SE2 of the transistor T8 are electrically connected to the second gate electrode GE2 of the output transistor PU-T1. The second source electrode SE2 of the transistor T6, the second gate electrode GE2 of the transistor T4, the second gate electrode GE2 of the transistor T8, the second source electrode SE2 of the transistor T12 and the second source electrode SE2 of the transistor T10 are electrically connected to each other. The second drain electrode DE2 of each of the transistor T4, the transistor T6, the transistor T8 and the transistor T12 is coupled to a reference potential (for example, VSS). The second gate electrode GE2 and the second drain electrode DE2 of the transistor T10 are electrically connected to each other and receive the second control signal from the power line PWL2. The second gate electrode GE2 of the transistor T12 receives the first control signal from the power line PWL1.

Similarly, the pull-down circuit DCb includes a transistor T5, a transistor T7, a transistor T9, a transistor T11 and a transistor T13. The second source electrode SE2 of the transistor T5 is electrically connected to the second drain electrode DE2 of the output transistor PU-T1. The second gate electrode GE2 of the transistor T7 and the second source electrode SE2 of the transistor T9 are electrically connected to the second gate electrode GE2 of the output transistor PU-T1. The second source electrode SE2 of the transistor T7, the second gate electrode GE2 of the transistor T5, the second gate electrode GE2 of the transistor T9, the second source electrode SE2 of the transistor T13 and the second source electrode SE2 of the transistor T11 are electrically connected to each other. The second drain electrode DE2 of each of the transistor T5, the transistor T7, the transistor T9 and the transistor T13 is coupled to the reference potential (for example, VSS). The second gate electrode GE2 and the second drain electrode DE2 of the transistor T11 are electrically connected to each other and receive the first control signal from the power line PWL1. The second gate electrode GE2 of the transistor T13 receives the second control signal from the power line PWL2.

When the gate driving circuit GDC receives a scan start signal, the shift register circuits SRC coupled in series sequentially output the gate driving signals to the scan lines GL of the display area DA in a time sequence to respectively control the pixel structures PX and display images through a display medium layer (such as the liquid crystal layer LCL in FIG. 3). After the last stage shift register circuit SRC outputs the gate driving signal, the gate driving circuit GDC may receive a scan termination signal, and at this time, the image update of one frame cycle is completed.

Referring to FIG. 5A, FIG. 5B and FIG. 6C, furthermore, the light shielding pattern layer SPL-A of the display panel 10A may be disposed around the second gate electrodes GE2 of the aforementioned transistors T. More specifically, the light shielding pattern layer SPL-A has multiple second openings OP2 overlapping the second gate electrodes GE2 of the transistors T. In the embodiment, an orthogonal projection of the second opening OP2 of the light shielding pattern layer SPL-A on the substrate SUB1 is located within an orthogonal projection of the second gate electrode GE2 on the substrate SUB1.

For example, the light shielding pattern layer SPL-A may further overlap a part of the second gate electrode GE2. Namely, in the embodiment, an area of the orthogonal projection of the second opening OP2 on the substrate SUB1 may be smaller than an area of the orthogonal projection of the second gate electrode GE2 on the substrate SUB1, but the disclosure is not limited thereto. In other embodiments, a profile of the orthogonal projection of the second opening OP2 on the substrate SUB1 may be aligned with a profile of the orthogonal projection of the second gate electrode GE2 on the substrate SUB1. In addition, there are gaps between some of the second gate electrodes GE2 of the transistors T of the shift register circuit SRC (as shown in FIG. 6B), and most of the gaps may be shielded by the light shielding pattern layer SPL-A.

Referring to FIG. 7 at the same time, it may effectively prevent light (such as ambient light ABL) incident from one side of the substrate SUB1 from irradiating the second semiconductor pattern SC2 through the edge of the second gate electrode GE2, through multiple reflections of the second gate electrode GE2 and the second source electrode SE2, or through multiple reflections of the second gate electrode GE2 and the second drain electrode DE2, so as to ensure that operating electrical properties of the display panel 10 will not be affected by light irradiation.

The light shielding pattern layer SPL-A and the second gate electrode GE2 are electrically insulated from each other due to the insulating layer 110 provided there between. In the embodiment, the light shielding pattern layer SPL-A is, for example, a metal layer, and a material thereof includes, for example, molybdenum, aluminum, copper, nickel, chromium, alloys thereof, or a stacked structure thereof. For example, in the embodiment, the light shielding pattern layer SPL may have a floating potential, but the disclosure is not limited thereto. However, the disclosure is not limited thereto. In other embodiments, the light shielding pattern layer may also be a black resin material layer. Namely, the light shielding pattern layer may not have conductivity.

Referring to FIG. 5A, in the embodiment, in order to bond the substrate SUB1 and the substrate SUB2 to form a cavity filled with the liquid crystal layer LCL, the display panel 10A further includes a glue pattern GP. The glue pattern GP is disposed in the peripheral area PA. Although not shown in the figure, the glue pattern GP is substantially arranged around the display area DA. It should be noted that an extension path of the glue pattern GP may overlap a part of the gate driving circuit GDC. More specifically, the glue pattern GP may cover multiple signal lines, a part of the shift register circuit SRC and a part of the light shielding pattern layer SPL-A (as shown in FIG. 6A to FIG. 6C). In the embodiment, the glue pattern GP has an outer edge GPe away from the display area, and a distance dl between one of the signal lines closest to the outer edge GPe of the glue pattern GP (for example, the power line PWL2) and the outer edge GPe is within a range of 200 μm to 250 μm.

For example, in the embodiment, a material of the glue pattern GP is, for example, a photo-curing glue or a photosensitive glue. Since the substrate SUB2 of the display panel 10A is provided with a light shielding layer (not shown) in the peripheral area PA, during a curing process of the glue pattern GP, light (such as ultraviolet light) is incident on the display panel 10A from the substrate SUB1. In order to ensure that the glue pattern GP may achieve a high photo-curing rate during a manufacturing process, a light transmittance of the portion of the light shielding pattern layer SPL-A and the shift register circuit SRC covered by the glue pattern GP must be greater than 38%. Namely, in an overlapping area OLA of the glue pattern GP, the light shielding pattern layer SPL-A, and the shift register circuit SRC, a percentage of an area of orthogonal projections of the light shielding pattern layer SPL-A and the shift register circuit SRC located in the overlapping area OLA on the substrate SUB1 to an area of the overlapping area is less than 62%.

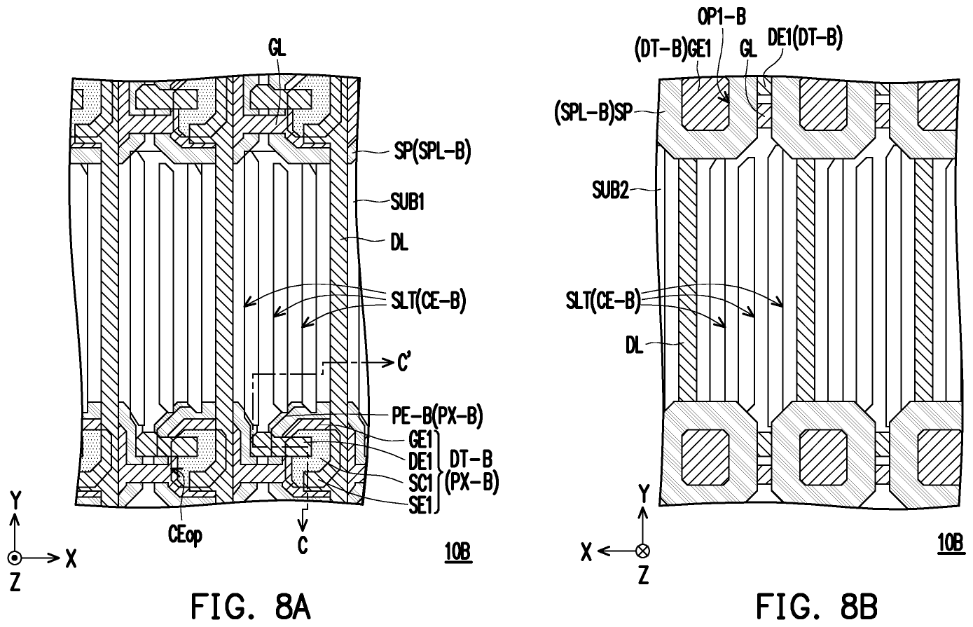

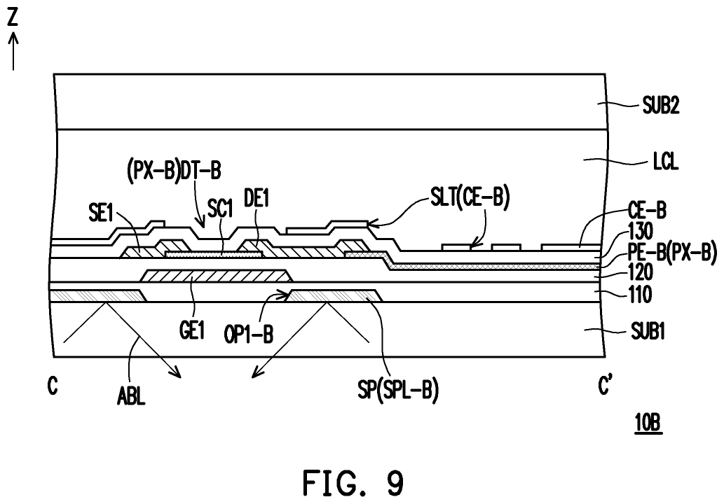

FIG. 8A is a schematic front view of a display panel according to a third embodiment of the disclosure. FIG. 8B is a schematic rear view of the display panel of FIG. 8A. FIG. 9 is a schematic cross-sectional view of the display panel of FIG. 8A. FIG. 9 corresponds to a section line C-C′ of FIG. 8A.

Referring to FIG. 8A, FIG. 8B and FIG. 9, a main difference between a display panel 10B of the embodiment and the display panel 10 of FIG. 2A lies in a different configuration of the light shielding pattern layer and the different pixel structures. For example, in the embodiment, a common electrode CE-B of a pixel structure PX-B may be selectively disposed above a pixel electrode PE-B, i.e., the pixel electrode PE-B is located between the common electrode CE-B and the substrate SUB1. More specifically, the pixel electrode PE-B is disposed on the gate insulating layer 120 and is electrically connected to the first drain electrode DE1 of a display transistor DT-B. However, the disclosure is not limited thereto. In other embodiments, the common electrode may also be disposed on the gate insulating layer 120 and located between the pixel electrode and the substrate SUB1. The pixel electrode penetrates through the insulating layer 130 to electrically connect the first drain electrode DE1 of the display transistor DT-B.

It is particularly noted that in the embodiment, the common electrode CE-B may have multiple micro slits SLT overlapping the pixel electrode PE-B and an opening CEop overlapping the first semiconductor pattern SC1 of the display transistor DT-B. More specifically, the pixel structure PX-B of the display panel 10B of the embodiment drives the liquid crystal layer LCL in a fringe-field switching (FFS) mode, but the disclosure is not limited thereto. In other embodiments, the pixel structure of the display panel may further drive the liquid crystal layer LCL in an in-plane switching (IPS) mode. On the other hand, in the embodiment, the common electrodes CE-B of the pixel structures PX-B are connected to each other. More specifically, the common electrodes CE-B may also overlap one of the scan lines GL and one of the data lines DL.

In the embodiment, a light shielding pattern layer SPL-B may include multiple light shielding patterns SP separated from each other. The light shielding patterns SP respectively have multiple first openings OP1-B overlapping the first gate electrodes GE1 of the display transistors DT-B. For example, the light shielding pattern layer SPL-B may further overlap a part of the first gate electrodes GE1. Namely, in the embodiment, an area of an orthogonal projection of the first opening OP1-B on the substrate SUB1 may be smaller than an area of the orthogonal projection of the first gate electrode GE1 on the substrate SUB1, but the disclosure is not limited thereto. In other embodiments, a profile of the orthogonal projection of the first opening OP1 on the substrate SUB1 may be aligned with a profile of the orthogonal projection of the first gate electrode GE1 on the substrate SUB1.

From another point of view, an orthogonal projection of the light shielding pattern layer SPL-B on the substrate SUB1 may surround an orthogonal projection of the first gate electrode GE1 on the substrate SUB2 (as shown in FIG. 8B). Accordingly, it may effectively prevent light (such as ambient light ABL) incident from one side of the substrate SUB1 from irradiating the first semiconductor pattern SC1 through the edge of the first gate electrode GE1, through multiple reflections of the first gate electrode GE1 and the first source electrode SE1, or through multiple reflections of the first gate electrode GE1 and the first drain electrode DE1. Namely, the light shielding pattern SP may shield the light incident from the substrate SUB1 (as shown in FIG. 9), so as to ensure that operating electrical properties of the display panel 10B will not be affected by light irradiation.

In summary, in the display panel according to an embodiment of the disclosure, since the light shielding pattern layer is provided between the first gate electrode of the display transistor of the pixel structure and the substrate, a leakage problem of the display transistor caused by light being incident around the first gate or being irradiated to the first semiconductor pattern after multiple reflections by the first gate electrode, the first source electrode and the first drain electrode is avoided, so as to ensure operating electrical properties of the display panel under light sources from different directions. In addition, through the openings provided in the light shielding pattern layer at a place overlapping the first gate electrode, flatness of a film layer around the display transistor is further improved, which helps to improve a yield of a subsequent film-forming process.

Finally, it should be noted that: the above embodiments are only used to illustrate the technical solution of the disclosure, but not to limit it; although the disclosure has been described in detail with reference to the foregoing embodiments, those of ordinary skill in the art should understood that the technical solutions described in the foregoing embodiments may still be modified, or some or all of the technical features may be equivalently replaced; and these modifications or substitutions do not cause the essence of the corresponding technical solution to depart from the scope of the technical solution of each embodiment of the present disclosure.

What is claimed is:

1. A display panel, comprising:
a substrate, provided with a display area;
a plurality of scan lines and a plurality of data lines, disposed on the substrate, and intersecting with each other;
a plurality of pixel structures, disposed in the display area, and respectively comprise:
a display transistor, comprising a first semiconductor pattern, a first gate electrode, a first source electrode, and a first drain electrode, wherein the first gate electrode is disposed between the substrate and the first semiconductor pattern, and is electrically connected to one of the scan lines, and the first source electrode is electrically connected to one of the data lines; and
a pixel electrode, electrically connected to the first drain electrode of the display transistor; and
a light shielding pattern layer, disposed between the first gate electrode and the substrate, and having a first opening overlapping the first gate electrode.

2. The display panel according to claim 1, wherein an orthogonal projection of the first opening of the light shielding pattern layer on the substrate is located within an orthogonal projection of the first gate electrode on the substrate.

3. The display panel according to claim 1, wherein an orthogonal projection of the light shielding pattern layer on the substrate surrounds an orthogonal projection of the first gate electrode on the substrate.

4. The display panel according to claim 1, wherein each of the pixel structures further comprises:
a common electrode, disposed between the pixel electrode and the substrate, and overlapping the pixel electrode, wherein orthogonal projections of the common electrode and the first gate electrode on the substrate have a first gap, and the first gap is located within an orthogonal projection of the light shielding pattern layer on the substrate.

5. The display panel according to claim 4, wherein orthogonal projections of the common electrode and an adjacent one of the data lines on the substrate have a second gap, and the second gap is located within the orthogonal projection of the light shielding pattern layer on the substrate.

6. The display panel according to claim 4, wherein orthogonal projections of the common electrode and an adjacent one of the scan lines on the substrate have a third gap, and the third gap is located within the orthogonal projection of the light shielding pattern layer on the substrate.

7. The display panel according to claim 4, wherein the each of the pixel structures of the display panel further comprises:
a reflective layer, covering the pixel electrode, and electrically connected to the pixel electrode, wherein the reflective layer defines a reflective area of the pixel structure, and a portion of the pixel electrode that is not covered by the reflective layer defines a transmissive area of the pixel structure; and
a capacitive electrode, disposed in the reflective area, and overlapping the common electrode, wherein the pixel electrode is electrically connected to the first drain electrode of the display transistor through the capacitive electrode.

8. The display panel according to claim 4, wherein the orthogonal projection of the light shielding pattern layer on the substrate surrounds an orthogonal projection of the common electrode on the substrate.

9. The display panel according to claim 1, wherein the light shielding pattern layer has a floating potential.

10. The display panel according to claim 1, further comprising:
a gate driving circuit, disposed in a peripheral area outside the display area, and comprising a plurality of shift register circuits, wherein the shift register circuits are electrically connected to the scan lines respectively, and each of the shift register circuits comprises a plurality of transistors, each of the transistors comprises a second semiconductor pattern, a second gate electrode, a second source electrode, and a second drain electrode, the second gate electrode is disposed between the substrate and the second semiconductor pattern, the second source electrode and the second drain electrode respectively contact two different areas of the second semiconductor pattern, wherein the light shielding pattern layer further has a second opening overlapping the second gate electrode.

11. The display panel according to claim 10, wherein an orthogonal projection of the second opening of the light shielding pattern layer on the substrate is located within an orthogonal projection of the second gate electrode on the substrate.

12. The display panel according to claim 10, wherein an orthogonal projection of the light shielding pattern layer on the substrate surrounds an orthogonal projection of the second gate electrode on the substrate.

13. The display panel according to claim 10, further comprising:
a glue pattern, disposed in the peripheral area; and
a plurality of signal lines, disposed in the peripheral area, and electrically connected to the shift register circuits, wherein a light transmittance of portions of the signal lines, the shift register circuits, and the light shielding pattern layer covered by the glue pattern is greater than 38%.

14. The display panel according to claim 13, wherein the glue pattern has an outer edge away from the display area, and a distance between one of the signal lines closest to the outer edge of the glue pattern and the outer edge is within a range of 200 μm to 250 μm.

15. The display panel according to claim 10, wherein each of the shift register circuits comprises an output stage circuit, the output stage circuit is configured with an output transistor of the transistors, the second gate electrode of the output transistor is electrically connected to a pull-down circuit and a pull-up circuit, the second drain electrode of the output transistor is electrically connected to one of the scan lines, the second source electrode of the output transistor is electrically connected to a clock signal line, wherein the pull-down circuit and the pull-up circuit are respectively configured with a part of the transistors.

16. The display panel according to claim 1, wherein the light shielding pattern layer comprises a plurality of light shielding patterns separated from each other, the light shielding patterns respectively have the first openings overlapping the first gate electrodes of the display transistors.

17. The display panel according to claim 1, wherein the pixel structures respectively comprise:
a common electrode, disposed on the substrate, overlapping the pixel electrode, and having an opening overlapping the first semiconductor pattern.

18. The display panel according to claim 17, wherein the pixel electrode is located between the common electrode and the substrate, the common electrode is configured with a plurality of micro-slits, and the micro-slits overlap the pixel electrode.

19. The display panel according to claim 18, wherein the common electrode further overlaps one of the data lines and one of the scan lines.

20. The display panel according to claim 1, wherein the light shielding pattern layer is a metal layer or a black resin material layer.
